(19) United States
(12) Patent Application Publication
(10) Pub. No.: US 2024/0217041 A1
(43) Pub. Date: Jul. 4, 2024

(54) TOOLING BASE WITH EJECTOR COMPONENTS

(71) Applicant: 5th Axis Inc., San Diego, CA (US)

(72) Inventors: Chris TAYLOR, San Diego, CA (US); Steve GRANGETTO, San Diego, CA (US); Adam LANE, San Diego, CA (US)

(73) Assignee: 5th Axis Inc., San Diego, CA (US)

(21) Appl. No.: 18/400,464

(22) Filed: Dec. 29, 2023

Related U.S. Application Data
(60) Provisional application No. 63/478,300, filed on Jan. 3, 2023.

(51) Int. Cl. B23Q 1/44

(52) U.S. Cl. CPC B23Q 1/44

(57) ABSTRACT

An improved tooling base, including: a base housing having an interior and registration holes, the registration holes being configured to receive alignment studs attached to the tooling fixture; a clamping system fit into the interior of the base housing, wherein the clamping system comprises a first device configured to secure, when adjusted to a first position, the tooling fixture to the tooling base via interaction with an indentation on each of the alignment studs and configured to release, when adjusted to a second position, a hold on the indentation on the alignment studs, thereby enabling removal of the tooling fixture from the tooling base; and one or more ejector components positioned in the base, whereby movement of an actuator causes the one or more ejector components to move upwards such that a portion of the one or more ejector components extends out from a top surface of the base.

### CROSS REFERENCE TO RELATED APPLICATIONS

This application claims priority to U.S. Provisional Application No. 63/478,300 filed Jan. 3, 2023, which is incorporated by reference herein in its entirety.

### TECHNICAL FIELD

Aspects of the present disclosure relate generally to tooling bases that are used to attach a variety of tooling fixtures that would hold a work piece to a work surface for machining, and, more specifically, to embodiments of tooling bases that allow the fixtures to be pneumatically attached and removed from the tooling base, all while maintaining registration accuracy.

### BACKGROUND

A tooling fixture is used to hold a work piece during intricate machining such as 5-axis machining. The fixture system requires that the work piece be held securely and precisely and provides access to a machine tool to all facets of the work piece. Preferably, it is possible to prepare the raw stock and easily and removably mount the stock in the fixture to present to a machine to create a part. Often, tooling fixtures are mounted directly to the bed or work surface of the milling machine. However, in many cases, it is necessary to process a part on different machines, requiring the part to be removed from one machine, worked or processed elsewhere and returned to the first machine. In certain circumstances, removal of the tooling fixture may be difficult to de-couple from the tooling base.

The present disclosure is accordingly directed to an improved tooling base having ejector pins that may aid in the removal of the tooling fixture. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

The entire disclosure of commonly owned U.S. Pat. No. 10,987,769, which discloses a tooling base for securing tooling fixtures, is incorporated by reference herein except for any definitions, subject matter disclaimers or disavowals, and except to the extent that the incorporated material is inconsistent with the express disclosure herein, in which case the language in this disclosure controls.

### SUMMARY OF THE DISCLOSURE

According to certain aspects of the disclosure, a tooling base with pneumatically-activated ejector components for detaching a tooling fixture is disclosed.

In one aspect, a tooling base for removably aligning and attaching a tooling fixture to a work surface of a machine is provided. The tooling base may include: a base housing having an interior and registration holes, the registration holes being configured to receive alignment studs attached to the tooling fixture; a clamping system fit into the interior of the base housing, wherein the clamping system comprises a first device configured to secure, when adjusted to a first position, the tooling fixture to the tooling base via interaction with an indentation on each of the alignment studs; the first device further configured to release, when adjusted to a second position, a hold on the indentation on each of the alignment studs, thereby enabling removal of the tooling fixture from the tooling base; and one or more ejector components positioned in the base, whereby movement of an actuator causes the one or more ejector components to move upwards such that a portion of the one or more ejector components extends out from a top surface of the base.

In another aspect, a tooling fixture release system is provided. The tooling fixture release system may include: a tooling base configurable between a clamped state and an unclamped state, wherein the tooling base includes registration holes configured to receive alignment studs attached to a tooling fixture; an internal clamp contained within the tooling base, wherein the internal clamp is configured to engage the alignment studs within the registration holes in the clamped state and disengage the alignment studs in the unclamped state; and an ejector component residing within an ejector hole located in a precision zone on a surface of the tooling base, the ejector component being selectively movable between a withdrawn state and a raised state via actuation of an actuator.

In yet another aspect, an ejector component of a tooling base is provided. The ejector component may include: a body having a first end and a second end, the first end configured for insertion into an ejector hole of the tooling base; a first port hole formed proximate to the second end of the body and a second port hole formed proximate to the first end; and a spring coupled to the first end of the body to an actuator housed within the tooling base; wherein the ejector component is selectively movable between a withdrawn state and a raised state, with respect to a surface of the tooling base, via manipulation of the actuator.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 depicts a top perspective view of an exemplary tooling base in a clamped state in which a tooling fixture is secured via alignment studs, according to various aspects of the present disclosure.

FIG. 2 depicts a top perspective view of an exemplary tooling base in an unclamped state with ejector pins deployed and the tooling fixture unsecured, according to various aspects of the present disclosure.

FIG. 3 depicts details of an exemplary embodiment of the internal components of the tooling base, including the ejector pins, when the tooling base is in a clamped state, according to various aspects of the present disclosure.

FIG. 4 depicts details of an exemplary embodiment of the internal components of the tooling base, including the ejector pins, when the tooling base is in an unclamped state, according to various aspects of the present disclosure.

FIG. 5 depicts a magnified view of an ejector pin when the tooling base is in an unclamped state, according to various aspects of the present disclosure.

FIG. 6 depicts a top perspective view of another exemplary tooling base in a clamped state in which a tooling fixture is secured via alignment studs, according to various aspects of the present disclosure.

FIG. 7 depicts a top perspective view of another exemplary tooling base in an unclamped state with ejector pins deployed and the tooling fixture unsecured, according to various aspects of the present disclosure.

FIG. 8 depicts a magnified view of a top surface of the exemplary tooling base in FIG. 7, according to various aspects of the present disclosure.

FIG. 9 depicts details of an exemplary embodiment of the internal components of another tooling base, including the ejector pins, when the tooling base is in a clamped state, according to various aspects of the present disclosure.

FIG. 10 depicts details of an exemplary embodiment of the internal components of another tooling base, including the ejector pins, when the tooling base is in an unclamped state, according to various aspects of the present disclosure.

FIG. 11 depicts details of an exemplary working configuration of another tooling base, according to various aspects of the present disclosure.

FIG. 12 depicts details of an exemplary working configuration of another tooling base, according to various aspects of the present disclosure.

### DETAILED DESCRIPTION OF THE EMBODIMENTS

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%.

In general, a tooling base is a system that attaches to a milling or other machining device and is precisely registered to that device. A vise or other fixture is then attached to the tooling base, again with precise registration to the tooling base, and therefore to the machining device. The tooling base further provides means to detach and re-attach a tooling fixture while maintaining precise registration. Tooling bases are known, such as those described in U.S. Pat. Nos. 9,902,033; 8,708,323; 10,603,750; U.S. Pat. Pub. No. 2007/0187909; German Pat. No. DE10117485B4; International Pat. Pub. No. WO 2000/053361A1; Japanese Pat. No. JP3085607B2; Japanese Pat. App. Laid Open No. Jitsu-Kai-Hei 5-26283U; and Japanese Pat. App. Laid Open No. Jitsu-Kai-Hei 5-56308U.

Although conventional tooling bases are designed to secure a tooling fixture, they are not optimized to aid in the removal of said fixture from the tooling base. Conventionally, separation of the tooling fixture from the tooling base is facilitated by a machining robot (e.g., a 6 axis robot, etc.). It is not unusual for these robots to suffer from deflection at the joints when reaching out with payloads. This deflection causes binding during loading of precision equipment, correspondingly causing the robot to alarm and stop. Any robot alarm means work downtown, which may be time-consuming and unproductive. Furthermore, particulate material resultant from the machining process may populate portions of the precision zone (i.e., the area of attachment where the alignment studs of the tooling fixture are inserted into the registration holes of the tooling base). The presence of these particulates may impede proper registration of subsequent tooling fixture attachment.

Accordingly, a need exists for an improved design in tooling bases that may facilitate easier removal of the tooling fixture from the tooling base. More particularly, there is a need for a tooling base that can push the tooling fixture out and away from the tooling base for easier robot pickup. Additionally, a further need exists for more efficient cleaning of the precision zone to ensure proper registration and attachment of the tooling fixture to the tooling base.

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims.

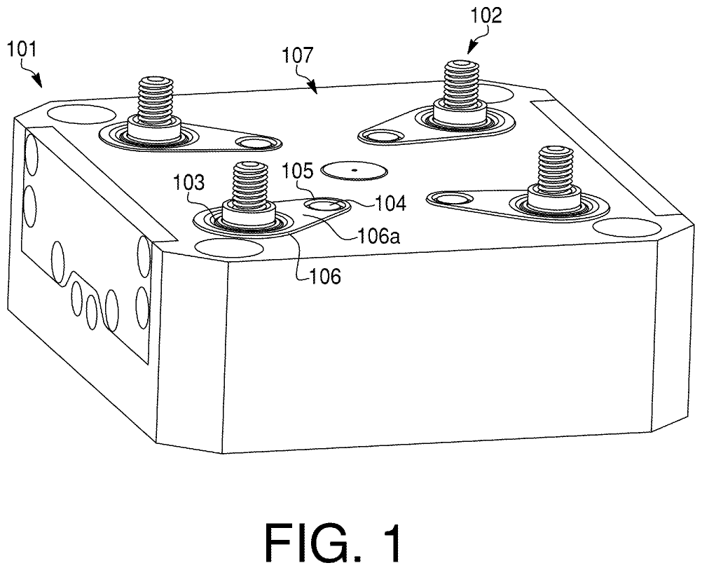

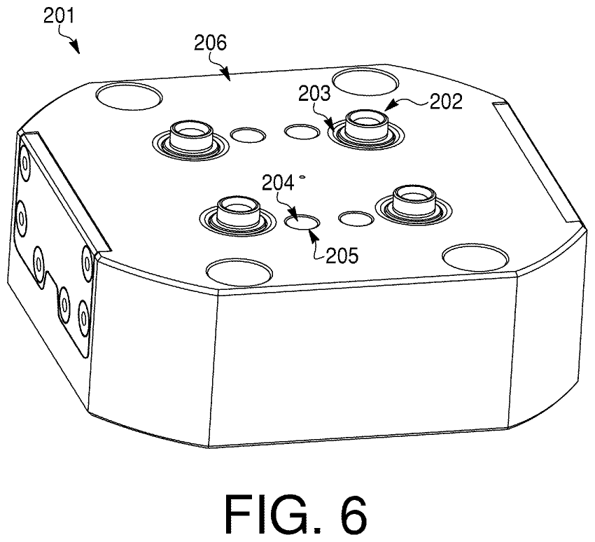

Referring now to FIG. 1, a tooling base 101 is shown in a clamped state. The tooling base 101 may be registered to the milling or other processing machine using tooling pins (not shown) and bolts (not shown), as are known in the art. In an embodiment, the tooling base 101 in the clamped state secures alignment studs 102 of a tooling fixture (not shown) inside registration holes 103 of the tooling base 101. This securement may be facilitated via actuation of an internal clamp (details not shown) that operates clamping fixtures to clamp the alignment studs 102 into the registration holes 103. In the clamped state, ejector components of the tooling base 101 may remain in a substantially withdrawn state inside ejector holes 105 located in a precision zone 106. For simplicity purposes, the ejector components illustrated and described throughout this application correspond to ejector pins 104. However, such a designation is not limiting, and one or more other component structures, having varying sizes and/or shapes, may also be utilized. In an embodiment, a top surface 106a of each precision zone 106 may be slightly raised over a top surface 107 of the tooling base 101. In this configuration, the tops of the ejector pins 104 may remain under or flush with the top surface 106a of each precision zone 106. Such a configuration, however, is not limiting and other embodiments may exist (e.g., in which tops of the ejector pins 104 remain under or flush with the top surface 107 of the tooling base 101, as further described herein and illustrated in FIGS. 6-10.

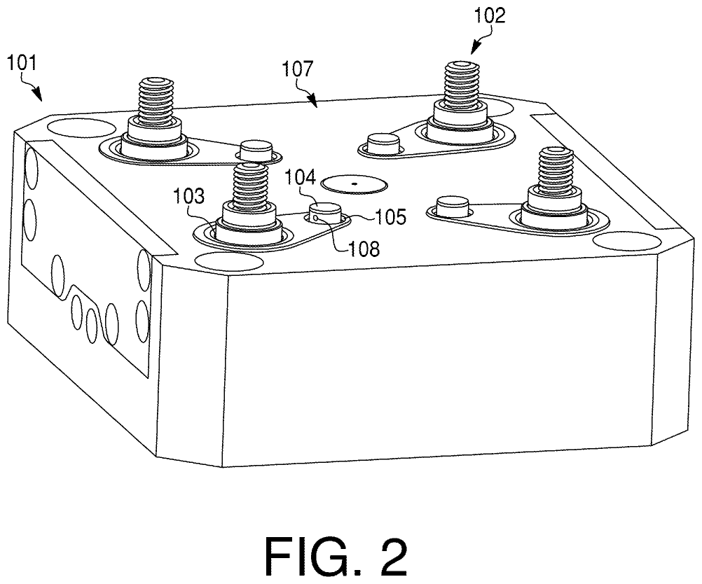

Referring now to FIG. 2, a tooling base 101 is shown in an unclamped state. In an embodiment, the tooling base 101 in the unclamped state may no longer effectively secure the tooling fixture to the tooling base (i.e., the clamping fixture may release its hold on the alignment studs 102, thereby enabling removal of the tooling fixture from the tooling base). Furthermore, in the unclamped state, the ejector pins 104 may be configured to rise out of the ejector holes 105 and extend above the top surface 106a of the precision zone 106, via a process that is further illustrated and described herein. The raised ejector pins 104 may correspondingly push the tooling fixture up and away from the tooling base 101, thereby aiding in the disengagement process and enabling easier removal of the tooling fixture by a machining robot (not pictured). In an embodiment, each of the ejector pins 104 may contain an upper port hole 108 that is oriented toward its corresponding alignment stud 102. In an embodiment, a chosen material or substance (e.g., air, fluid, etc.) may be expelled through the upper port hole 108 and may be directed at the corresponding precision zone 106 (e.g., via pneumatic actuation, etc.), as further illustrated and described herein. This action may function to clear any particulate matter resultant from the machining process off of the precision zones so that the surface of the tooling base 101 is clean and is ready to receive another tooling fixture. For simplicity purposes only, the remaining disclosure is described with reference to the utilization of compressed air as the substance that may be expelled from the upper port hole 108.

It is important to note that although four ejector pins are illustrated in FIGS. 1 and 2, such a number is not limiting and a tooling base may have more or less ejector pins. Additionally, the positioning of the ejector pins illustrated in FIGS. 1 and 2 is also not limiting, and the ejector pins may be located around other portions of the tooling base surface than what is shown. Additionally still, the perceived size of the ejector pins illustrated in FIGS. 1 and 2 is also not limiting, and the ejector pins may have a larger or smaller cylindrical circumference than what is shown. Additionally still, the size and/or number of upper air ports on each ejector pin illustrated in FIGS. 1 and 2 is also not limiting, and each ejector pin may have two or more upper air ports of the same or different size than what is shown.

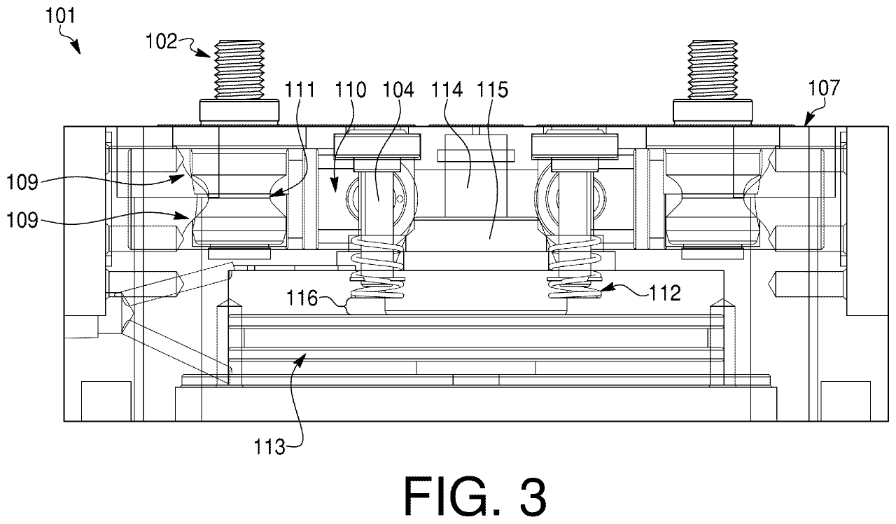

Referring now to FIG. 3, the configuration of the internal components of the tooling base 101 in a clamped state are illustrated. In the clamped state, tapered regions 109 of the clamping fixtures 110 engage indentations 111 on the alignment studs 102, and when fully tightened against the indentations 111 cause the alignment studs 102 to be clamped against the inner wall of the registration holes 103 and register the tooling fixture to the tooling base 101. Additional details regarding the functionality of the clamping fixtures 110 can be found in U.S. Pat. No. 10,987,769, which is incorporated by reference herein. Further illustrated in FIG. 3 are the ejector pins 104 and their internal positioning within the tooling base 101. As previously discussed with reference to FIG. 1, in the clamped state the top portions of the ejector pins 104 reside beneath the top surface 106a of the precision zones 106. In an embodiment, each of the ejector pins 104 may be spring loaded and may be coupled to a spring 112 located on the side of the ejector pin 104 remaining situated within the housing of the tooling base 101.

In an embodiment, a pneumatic actuator (e.g., a piston 113) may be present within the tooling base 101 and may ride up and down on an internal shaft 114. The piston 113 may be in contact with a cam 115 (i.e., which may be a tapered cylinder having a central opening through which the shaft 114 extends) that may engage with the clamping fixtures 110 to release the tooling fixture from the tooling base 101. In an embodiment, in the clamped state, the piston 113 may be positioned in a “down” state and may be separated from the ejector pins 104 by a gap 116. Additional details regarding the operation of the piston 113, including the methods by which compressed air or other fluids are provided to the tooling base 101, are detailed in U.S. Pat. No. 10,987,769, which is incorporated by reference herein.

It is important to note that although FIG. 3 is illustrated as having a gap 116 between the ejector pins 104 and the piston 113, such a configuration is not limiting. More particularly, other embodiments may exist (not explicitly illustrated here) in which the ejector pins and the piston are arranged differently with respect to each other than in FIG. 3. For example, in an embodiment, the ejector pins 104 may be directly mounted to the piston 113 and may rise and fall in unison with the piston operation.

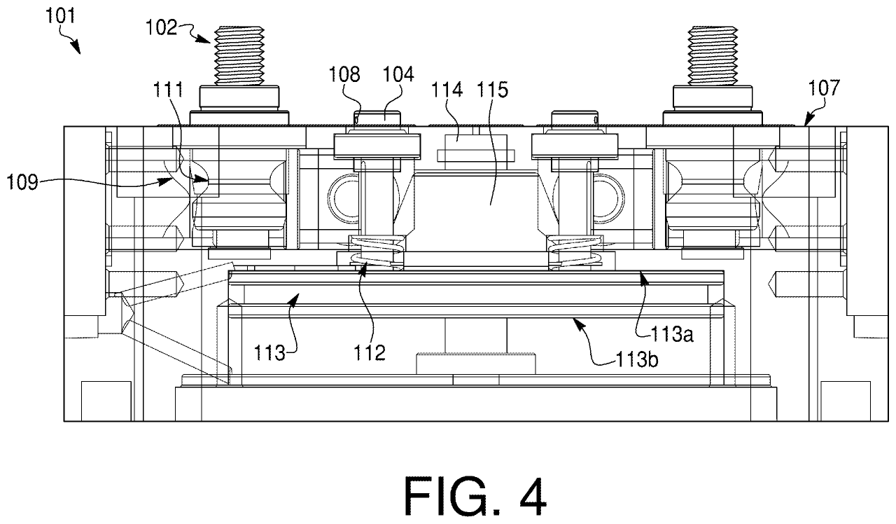

Referring now to FIG. 4, the configuration of the internal components of the tooling base 101 in an unclamped state are illustrated. In an embodiment, when there is a differential pressure between the top surface 113a and the bottom surface 113b of the piston 113 provided by compressed air or other fluid, and the pressure on the bottom surface 113b exceeds that of the top surface 113a by a specified margin, the piston 113 may rise upward along the shaft 114. If the pressure differential is sufficient so as to overcome friction and spring forces, the cam 115 may engage the clamping fixtures 110 and force the clamping fixtures apart to release the tooling fixture from the tooling base 101. Furthermore, contact of the top surface 113a of the piston 113 with the ejector pin 104 may push the ejector pin 104 up and out of the top surface 107 of the tooling base 101. Accordingly, in view of the foregoing, one application of compressed air to the tooling base 101 may be sufficient to both decouple the tooling fixture from the tooling base 101 and also raise the ejector pins 104 up and out of the top surface 107 of the tooling base 101.

In an embodiment, compressed air supplied to the tooling base 101 for automated operation is typically supplied by computer actuated valves, as are known in the art. In an embodiment, a computer system may be configured to supply the compressed air substantially immediately prior to the removal of the tooling fixture by a machining robot. Additionally or alternatively, the computer system may be configured to supply the compressed air only upon determination that the tooling fixture is secured by the robot. Additionally or alternatively, the computer system may be configured to supply the compressed air upon receipt of a user command at the computer system.

In an embodiment, in the unclamped state, the tapered regions 109 of the clamping fixtures 110 may disengage from the indentations 111 on the alignment studs 102, thereby enabling the alignment studs 102 to be removable from the registration holes 103. Additionally, the top portions of the ejector pins 104 in the unclamped state may protrude out of the top surface 107 of the tooling base 101, thereby further pushing the tooling fixture away from the tooling base 101. In an embodiment, the upper port holes 108 of the ejector pins 104 may reside above the top surface 107 of the tooling base 101 when the ejector pins 104 are pushed up.

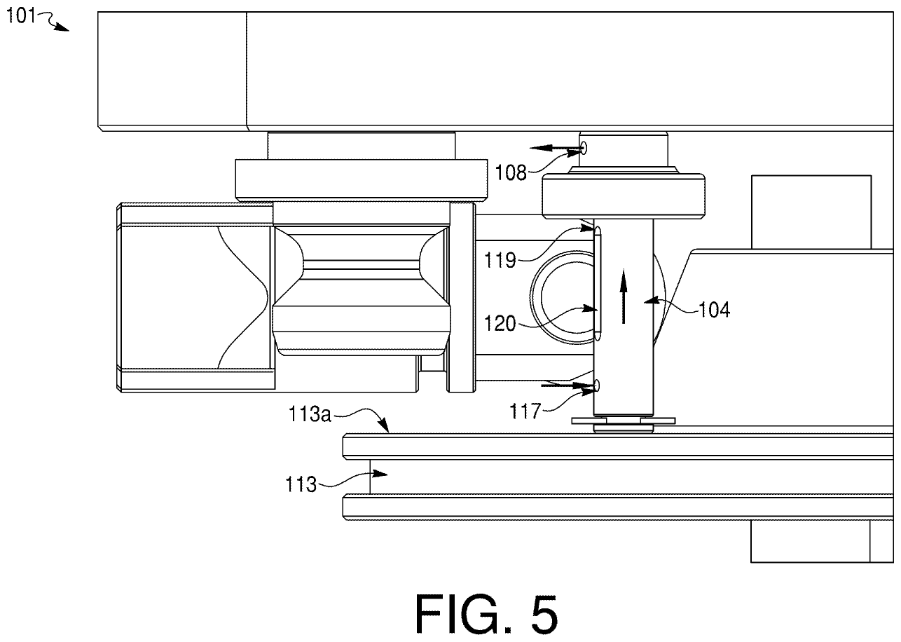

Referring now to FIG. 5, a magnified view of the details of the ejector pins 104 are provided. In an embodiment, each ejector pin 104 may contain a lower port hole 117 and an upper port hole 108. Compressed air, when provided to the tooling base 101 to actuate the piston 113, may enter the ejector pin 104 via the lower port hole 117, travel the vertical length of the ejector pin 104 along an internal pin shaft (not shown), and exit the ejector pin 104 as an air burst through the upper port hole 108. This air burst may clean any particulate matter away from the precision zone 106 so as to ensure that nothing impedes a tooling fixture upon subsequent registration. In an embodiment, each ejector pin 104 may further comprise a groove 119 containing a pin 120. In the configuration where only a single upper port hole 108 exists, the groove 119 and pin 120 aid in the alignment of the ejector pin 104 so that the upper port hole 108 is pointed directly at the top surface 106a of the precision zone 106 and the alignment stud 102.

FIGS. 6-10 depict another exemplary tooling base 201, according to one or more embodiments. The internal functionality of tooling base 201 may be substantially identical to that of tooling base 101 (i.e., the alignment stud clamping functionality and the operation of the ejection pins may be substantially the same).

Referring now to FIG. 6, tooling base 201 is illustrated in a clamped state. The tooling base 201 may be registered to the milling or other processing machine using tooling pins (not shown) and bolts (not shown), as are known in the art. Similar to tooling base 101, tooling base 201 may secure alignment studs 202 of a tooling fixture (not shown) inside registration holes 203. In the clamped state, ejector pins 204 of the tooling base 201 may remain in a substantially withdrawn state inside ejector holes 205. In this configuration, the tops of the ejector pins 204 may remain under or flush with the top surface 206 of the tooling base 201 (as opposed to under or flush with the top surface 106a of the precision zone 106 in tooling base 101).

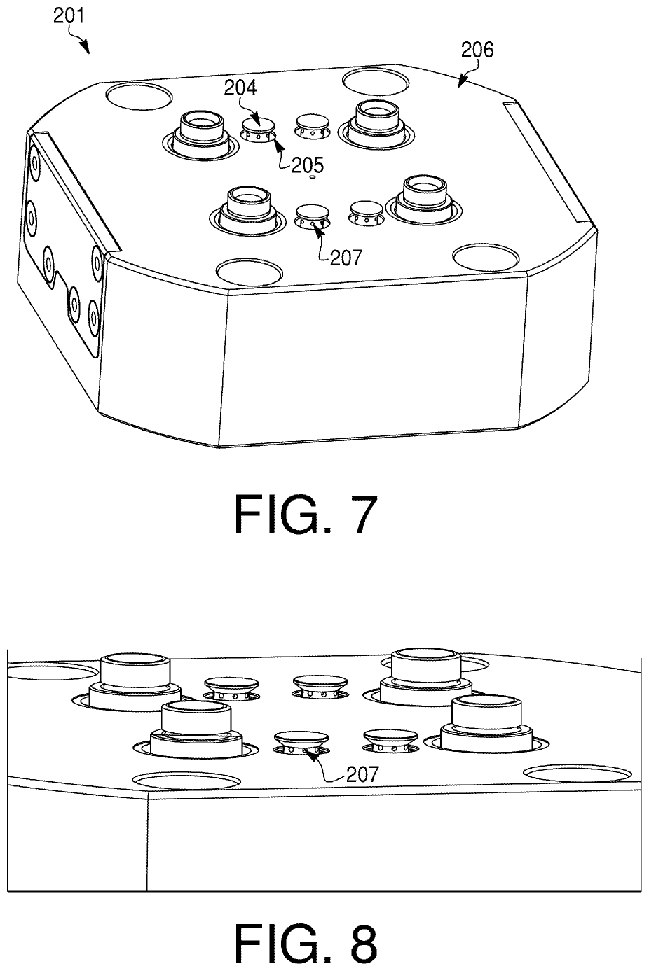

Referring now to FIG. 7, tooling base 201 is shown in an unclamped state. In the unclamped state, the ejector pins 204 may be configured to rise out of the ejector holes 205 and extend above the top surface 206 of the tooling base 201, via a process previously described above. The raised ejector pins 204 may correspondingly push the tooling fixture up and away from the tooling base 201. In an embodiment, each of the ejector pins 204 may contain a plurality of upper port holes 207. Although each ejector pin 204 in tooling base 201 may contain 8 upper port holes 207, such a number is not limiting. Similar to the ejector pins 104 in tooling base 101, a chosen material or substance (e.g., air, fluid, etc.) may be expelled through each of the upper port holes 207 substantially simultaneously. FIG. 8 provides an alternative, close-up view of the upper port holes 207 of the ejector pins 204 when the tooling base 201 is in the unclamped state.

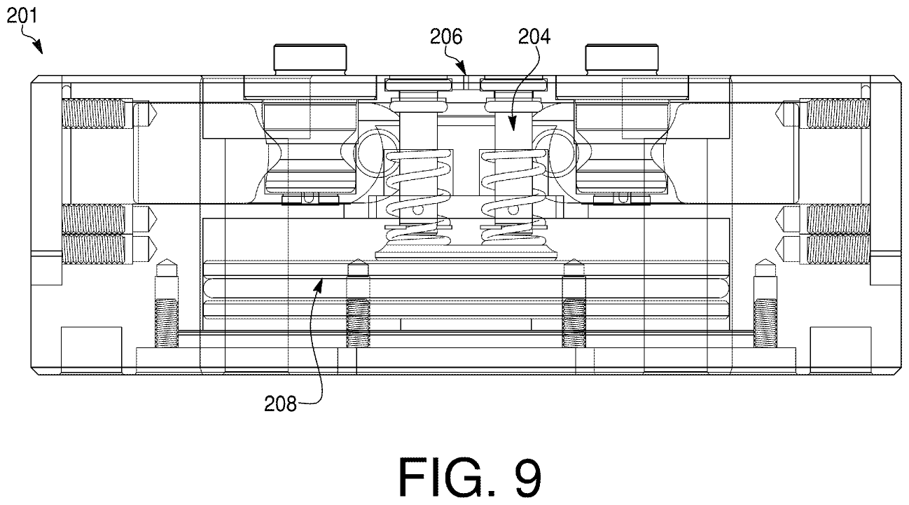

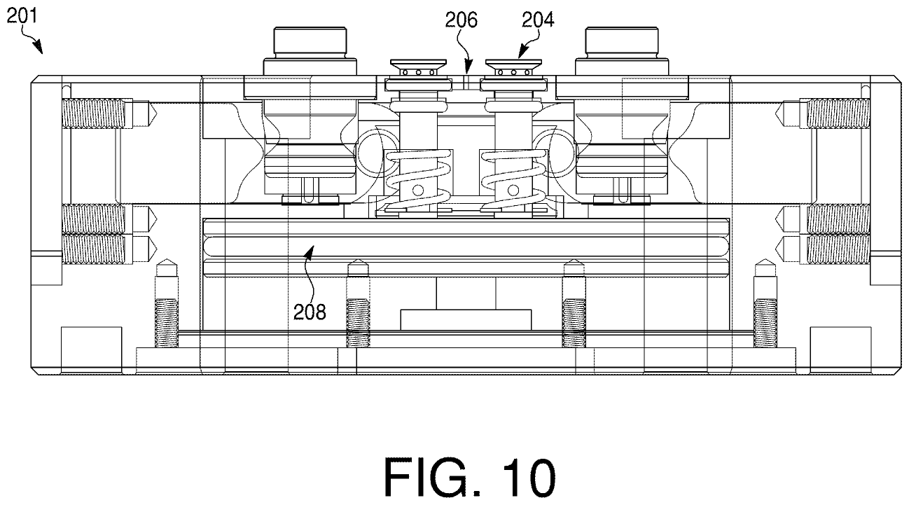

Referring now to FIG. 9, the configuration of the internal components of the tooling base 201 in a clamped state are illustrated. As previously discussed with reference to FIG. 6, in the clamped state the top portions of the ejector pins 204 reside beneath the top surface 206 of the tooling base 201. In an embodiment, each of the ejector pins 204 may be hard mounted to a pneumatic actuator (e.g., piston 208) present within the tooling base 201. Through this arrangement, the ejector pins 204 may rise in unison with the piston 208 during actuation to protrude through ejector holes 205 above the top surface 206 of the tooling base 201, as illustrated in FIG. 10.

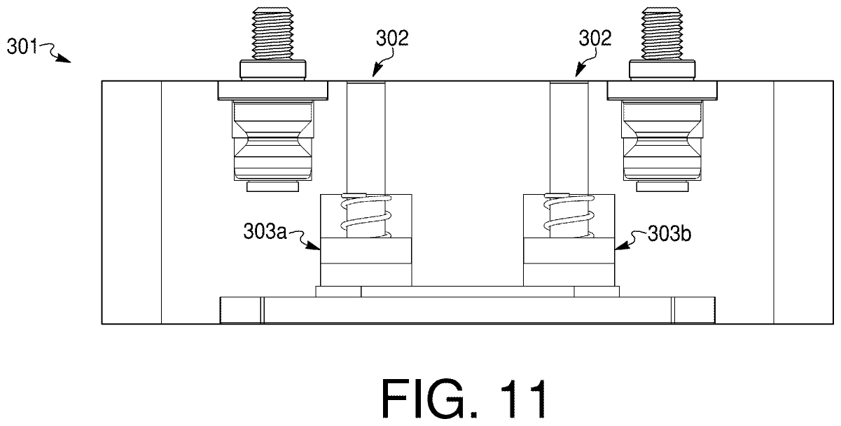

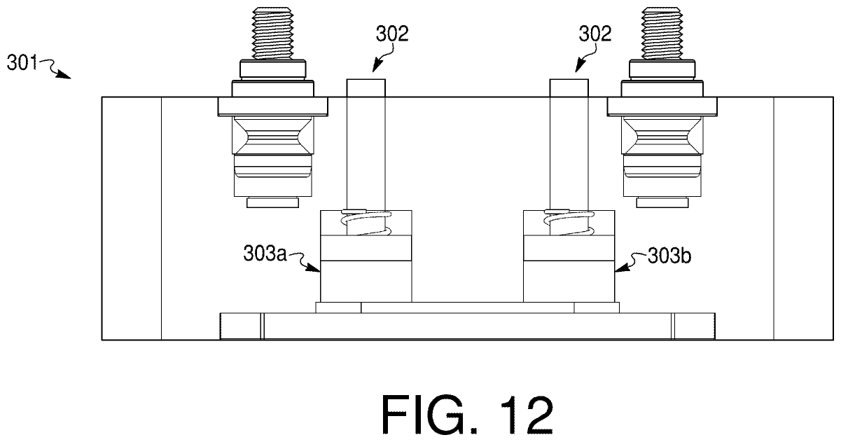

Referring now to FIG. 11, the ejector pins 302 of a tooling base 301 are illustrated in an exemplary working configuration. More particularly, the ejector pins 302 are positioned in a down state and, in the illustrated embodiment, each of the ejector pins 302 is hard mounted to a dedicated piston 303 (a-b) (i.e., one piston per ejector pin). However, as previously mentioned, such a designation is not limiting and multiple ejector pins can be mounted on a single, larger piston. In an embodiment, the ejector pins can be moved upwards from the down state to an up state, as illustrated in FIG. 12, in response to piston actuation by one of air, hydraulics, motor, or spring force. Similarly, the ejectors can be moved back down to the down state in response to piston actuation by one of air, hydraulics, motor, or spring force.

The many features and advantages of the present disclosure are apparent from the detailed specification, and thus, it is intended by the appended claims to cover all such features and advantages of the present disclosure that fall within the true spirit and scope of the disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. A tooling base for removably aligning and attaching a tooling fixture to a work surface of a machine, comprising:
a base housing having an interior and registration holes, the registration holes being configured to receive alignment studs attached to the tooling fixture;
a clamping system fit into the interior of the base housing, wherein the clamping system comprises a first device configured to secure, when adjusted to a first position, the tooling fixture to the tooling base via interaction with an indentation on each of the alignment studs;
the first device further configured to release, when adjusted to a second position, a hold on the indentation on each of the alignment studs, thereby enabling removal of the tooling fixture from the tooling base; and
one or more ejector components positioned in the base, whereby movement of an actuator causes one or more ejector components to move upwards such that a portion of the one or more ejector components extends out from a top surface of the base.

2. The tooling base of claim 1, wherein the actuator is a pneumatic actuator.

3. The tooling base of claim 2, wherein the pneumatic actuator comprises a piston.

4. The tooling base of claim 1, wherein each of the one or more ejector components comprises at least one upper port hole.

5. The tooling base of claim 4, wherein the movement of the actuator is resultant from an application of compressed air to the base and wherein the application of the compressed air causes a portion of the compressed air to enter a lower air port and exit via the at least one upper port hole.

6. The tooling base of claim 5, wherein the at least one upper port hole is oriented toward a precision zone surrounding the registration holes and wherein the portion of the compressed air exits the at least one upper port hole toward the precision zone.

7. The tooling base of claim 1, wherein each of the one or more ejector components is operably coupled to the actuator.

8. The tooling base of claim 1, wherein the actuator corresponds to a plurality of actuators and wherein each of the one or more ejector components is operably coupled to one of the plurality of actuators.

9. The tooling base of claim 1, wherein the first device is configured to secure the tooling fixture to the tooling base via one of: spring actuation, pneumatic actuation, or hydraulic actuation.

10. The tooling base of claim 1, wherein the second device is configured to unsecure the tooling fixture from the tooling base via one of: spring actuation, pneumatic actuation, or hydraulic actuation.

11. A tooling fixture release system, comprising:
a tooling base configurable between a clamped state and an unclamped state, wherein the tooling base includes registration holes configured to receive alignment studs attached to a tooling fixture;
an internal clamp contained within the tooling base, wherein the internal clamp is configured to engage the alignment studs within the registration holes in the clamped state and disengage the alignment studs in the unclamped state; and
an ejector component residing within an ejector hole located in a precision zone on a surface of the tooling base, the ejector component being selectively movable between a withdrawn state and a raised state via actuation of an actuator.

12. The tooling fixture release system of claim 11, wherein the ejector component comprises a port hole through which a substance is configured to be expelled during transition between the withdrawn state and the raised state.

13. The tooling fixture release system of claim 12, wherein the substance is compressed air.

14. The tooling fixture release system of claim 13, wherein the compressed air is configured to be provided to the tooling base via computer-actuated valves substantially immediately prior to removal of the tooling fixture from the tooling base.

15. The tooling fixture release system of claim 11, wherein the ejector component is connected to the actuator via a spring.

16. The tooling fixture release system of claim 11, wherein the actuator comprises a piston positioned within the tooling base, the piston being in contact with a cam that engages with an internal clamp to release the tooling fixture from the tooling base during the unclamped state.

17. An ejector component of a tooling base, comprising:
a body having a first end and a second end, the first end configured for insertion into an ejector hole of the tooling base;
a first port hole formed proximate to the second end of the body and a second port hole formed proximate to the first end; and
a spring coupled to the first end of the body to an actuator housed within the tooling base;
wherein the ejector component is selectively movable between a withdrawn state and a raised state, with respect to a surface of the tooling base, via manipulation of the actuator.

18. The ejector component of claim 17, further comprising an internal shaft that extends along an internal length of the body.

19. The ejector component of claim 18, wherein transition of the ejector component between the withdrawn state and the raised state causes a substance to enter the second port hole, traverse the internal shaft, and be expelled from the first port hole.

20. The ejector component of claim 17, further comprising a groove formed in the body, wherein the groove is configured to house a pin that orients the ejector component toward a predetermined direction.
